(19) United States
(12) Patent Application Publication
(10) Pub. No.: US 2021/0235253 A1
(43) Pub. Date: Jul. 29, 2021

(54) Mobile Gateways and Low-Power Transceivers

(71) Applicant: Arm IP Limited, Cambridge (GB)

(72) Inventor: Phillip Charles Smith, Great Cambourne (GB)

(73) Assignee: Arm IP Limited, Cambridge (GB)

(21) Appl. No.: 15/734,792

(22) PCT Filed: May 21, 2019
(86) PCT No.: PCT/GB2019/051396

§ 371 Date: Dec. 3, 2020

(30) Foreign Application Priority Data
Jun. 6, 2018 (GB) 1809274.2

(51) Int. Cl. H04W 8/00; H04W 4/20; G06Q 20/02; G06Q 30/02; G06Q 20/32; G06N 5/02

(52) U.S. Cl. CPC H04W 8/005; H04W 4/20; G06Q 20/027; H04W 88/16; G06Q 20/3224; G06N 5/02; G06Q 30/0215

(57) ABSTRACT

There is described a method and data processing apparatus for a mobile gateway, the mobile gateway is for exchanging data with a gateway server when the mobile gateway is in network range of the gateway server, the mobile gateway is for moving into wireless range of the remote transceiver and for exchanging data with the remote transceiver before moving back into network range with the gateway server and further exchanging data to the gateway server, the method comprising: receiving a request for data from a gateway server; sending data to gateway server; receiving a request to deliver a data payload to a remote transceiver; determining whether to accept or reject the request; and downloading the data payload for delivery to the remote transceiver if accepted whereby the request comprises an incentive offer whereby determining of the request comprises consideration of the incentive offer and acceptance of the request is conditional on acceptance of the incentive offer.

The present techniques relate to mobile gateways in a network of low power transceivers, mobile gateways and a controlling server.

A transceiver in a remote location cannot communicate with a server when the server network, in particular, a wireless network, does not cover the remote location. One solution for out of range transceivers is to use mobile gateways that move into/out of wireless network connectivity range with the server and into/out of wireless connectivity range with the transceiver to act as mobile data buffers. Although wireless connectivity is described, the same principles apply to a physical connectivity. A wireless mobile gateway solution is particularly useful in a low power transceiver system where most transceivers are out of wireless range of a central server and are effectively remote. Such a transceiver is typically a low power device without a large area data transceiver or large battery associated with a data transceiver. A known mobile gateway solution requires dedicated mobile gateways tightly managed by a central controller.

According to a first technique, there is provided a gateway server for exchanging data with a remote transceiver using an intermediate mobile gateway that transports the data between the respective data ranges of the gateway server and the remote transceiver, said gateway server comprising: a transceiver for requesting and receiving data from at least one mobile gateway; a mobile gateway identifying engine for identifying a participating mobile gateway and mobile gateway information from the received data; and a remote transceiver interface for identifying remote transceiver information from the received data.

According to a second technique, there is provided a mobile gateway for enabling exchange of data between a remote transceiver and gateway server by transporting the data between the respective data ranges of the gateway server and the remote transceiver prior to intermediate exchanges, the mobile gateway comprising: a transceiver for receiving requests from a gateway server to participate in data transport by sending mobile gateway information and/or remote transceiver information to the gateway server; a request engine for determining whether to accept or reject a participation request; and an upload manager for managing exchanging of data when in wireless network range of a gateway server or a remote transceiver.

According to a third technique, there is provided a method in a gateway server, the gateway server for exchanging data with a remote transceiver using an intermediate mobile gateway that transports the data between the respective data ranges of the gateway server and the remote transceiver, said method comprising: requesting participation in data transport from at least one mobile gateway; receiving data from a participating mobile gateway; identifying, from the received data, remote transceiver information and/or mobile gateway information.

According to a fourth technique, there is provided a method in a mobile gateway, the mobile gateway for enabling exchange of data between a remote transceiver and gateway server by transporting the data between the respective data ranges of the gateway server and the remote transceiver prior to intermediate exchanges, the method comprising: receiving a request to participate in data transport by exchanging remote transceiver information and/or mobile gateway information; determining whether to accept or reject the request; and exchanging information with the remote transceiver and/or the gateway server.

According to a fifth technique, there is provided a method in a remote transceiver, the remote transceiver is for exchanging data with a mobile gateway when the mobile gateway has moved into communication range of the remote transceiver, thereafter the mobile gateway moves out of range of the remote transceiver and into communication range with a gateway server for exchanging data, including previously exchanged data with the gateway server, the method comprising: receiving a participation request to exchange remote transceiver information with a mobile gateway; determining whether to accept the participation request; and exchanging data with the mobile gateway if acceptance is determined.

The embodiments are intended to include an independent phone carrying human or any independent mobile entity with a mobile device that can be crowd sourced as mobile gateway for a gateway server.

Using an independent mobile entity and device as a mobile gateway is possible for an end to end connection. When the remote device is deep underground or a place where connectivity is not available then an independent mobile gateway knows its own typical journeys and is able to cache the payload data which can be delivered to the low power transceiver next time it is in range. Data rates are likely to be low and latency will be high, but it enables many low power transceivers to be connected to a gateway server in circumstances where it would otherwise be unable to connect.

One example use case is an asset tracking system for tracking remote pallets whereby pallets have embedded low power transceivers (for instance Bluetooth transceivers) for communicating with mobile gateways. The embedded transceiver in a remote pallet is the remote transceiver. A pallet can be lost in a remote location and still communicate with a mobile gateway to relay its location and status back to a pallet tracker system and gateway server. Another use case is for remote lighting units using transceivers to communicate with the mobile devices of passing pedestrians. Lighting in remote locations like an underground system can now be given enough connectivity to provide useful information or to provide portions of a software update payload to the lighting. In one embodiment, a crowd sourcing application for participating in a tracking system which may be downloaded or pre-installed to run in the background on a mobile device. More generally, mobile devices can be instructed to transmit to or receive data from a remote transceiver once in communication range of that transceiver. In an example, a user of a mobile device may be provided with an estimate of the location of a remote transceiver and use that estimate to attempt to connect with the remote transceiver.

Other example remote spaces where embodiments can be used to spread internet connectivity for constrained IoT devices include: a vast remote space such as a desert where such radio signals cannot reach the whole space; an underground space where radio transmission cannot penetrate through earth; and an undersea space where radio signals find it hard to penetrate.

A first embodiment will be described with reference to the accompanying figures of which:

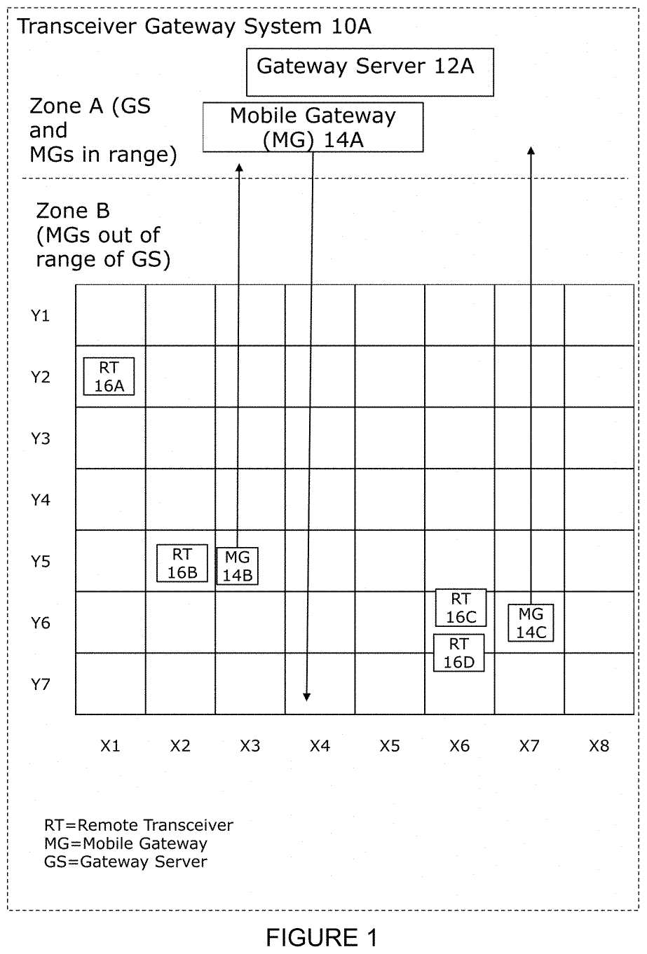

FIG. 1 is an example deployment diagram over two zoned areas;

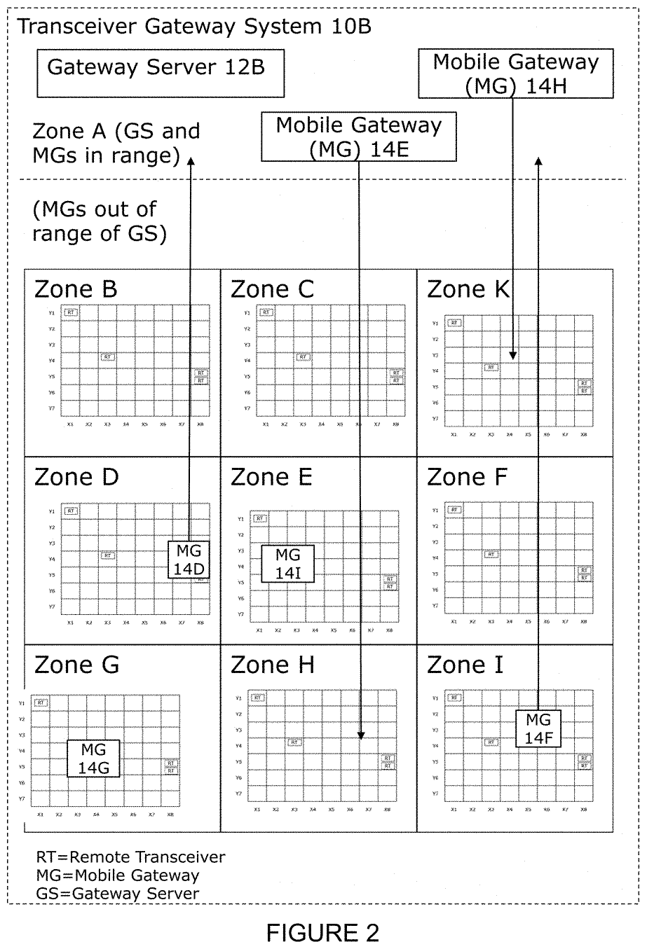

FIG. 2 is an example deployment diagram over multiple zoned areas;

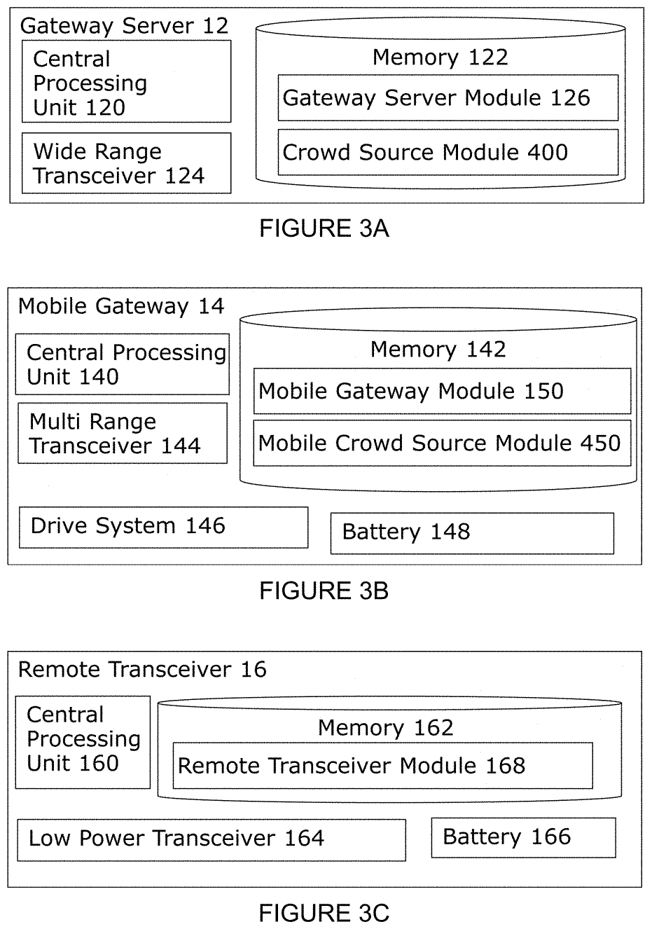

FIGS. 3A, 3B and 3C are deployment diagrams for a gateway server, a mobile gateway, and a remote transceiver;

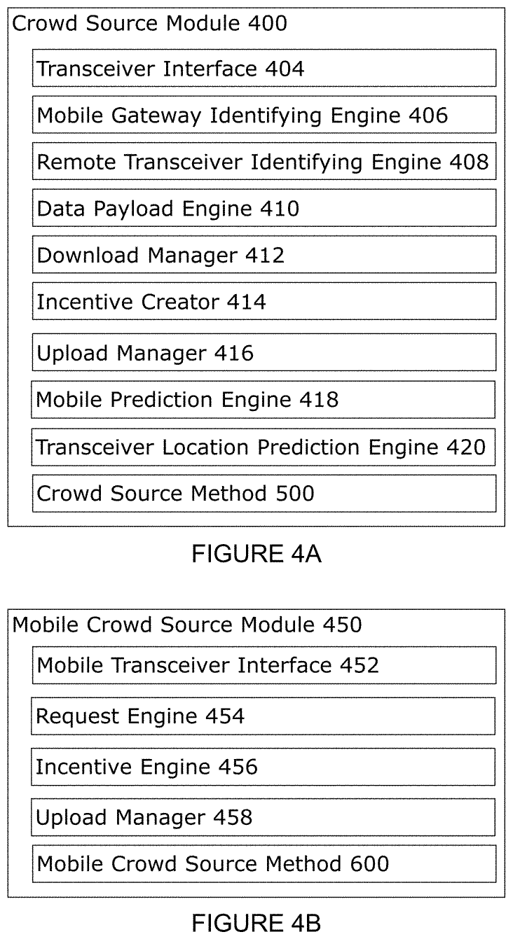

FIGS. 4A and 4B are component diagrams for a crowd source module and a mobile crowd source module respectively;

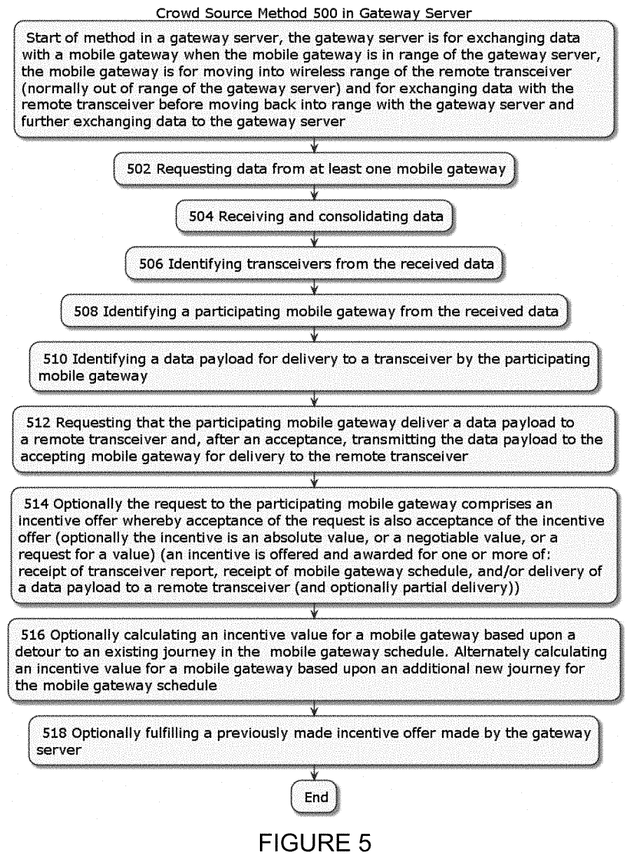

FIG. 5 is a method diagram for a crowd source method in a gateway server;

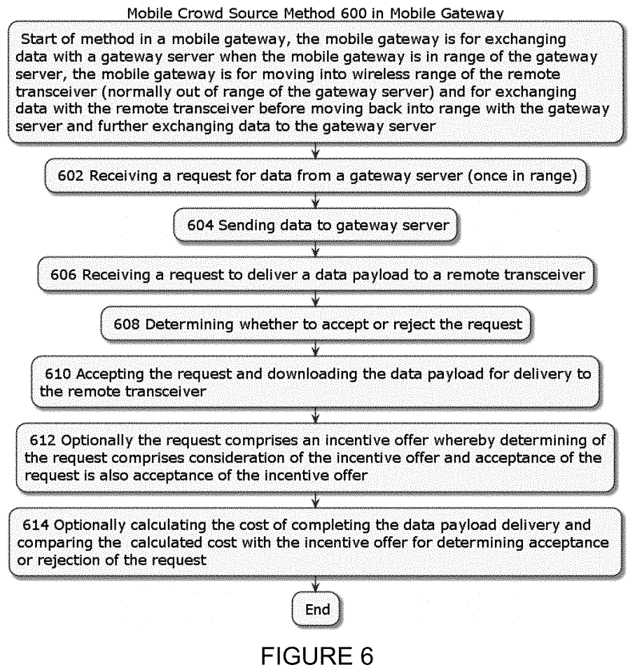

FIG. 6 is a method diagram for a mobile crowd source method in a mobile gateway;

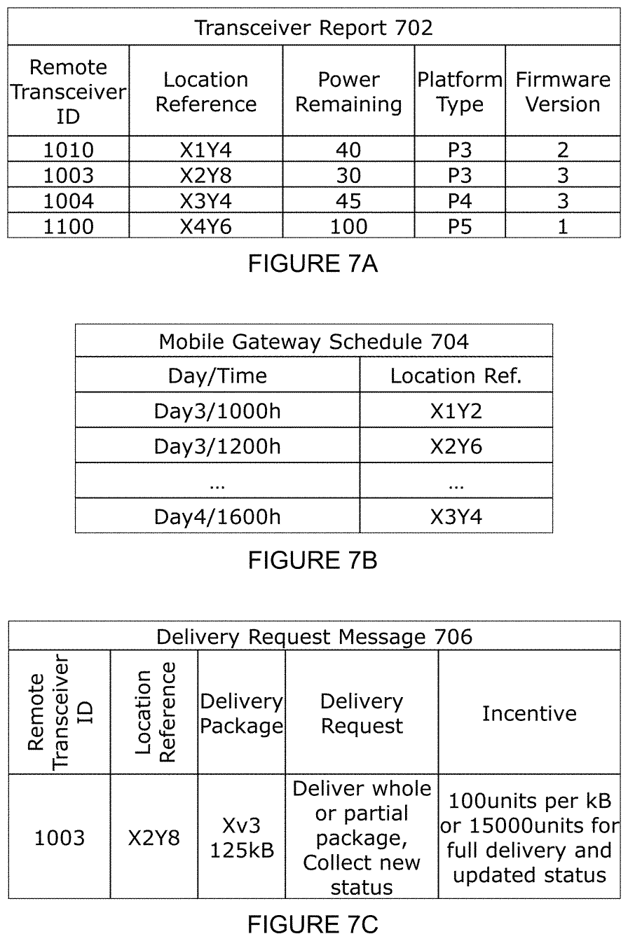

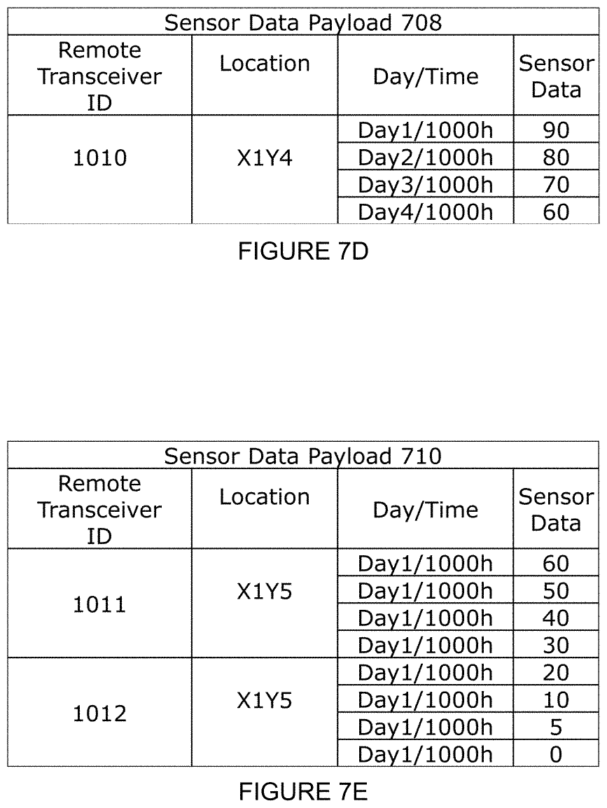

FIGS. 7A, 7B, 7C, 7D and 7E are example data message structure diagrams; and

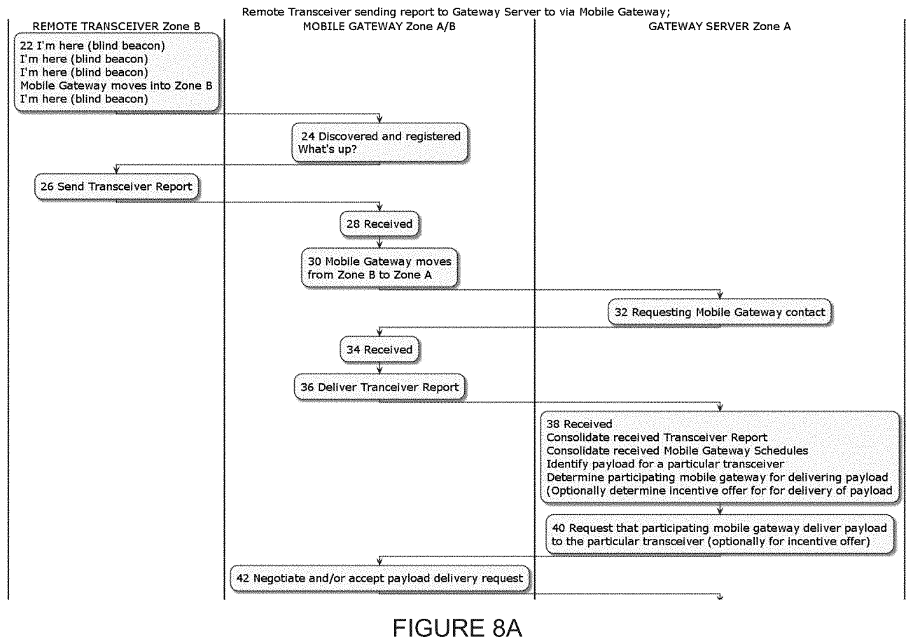

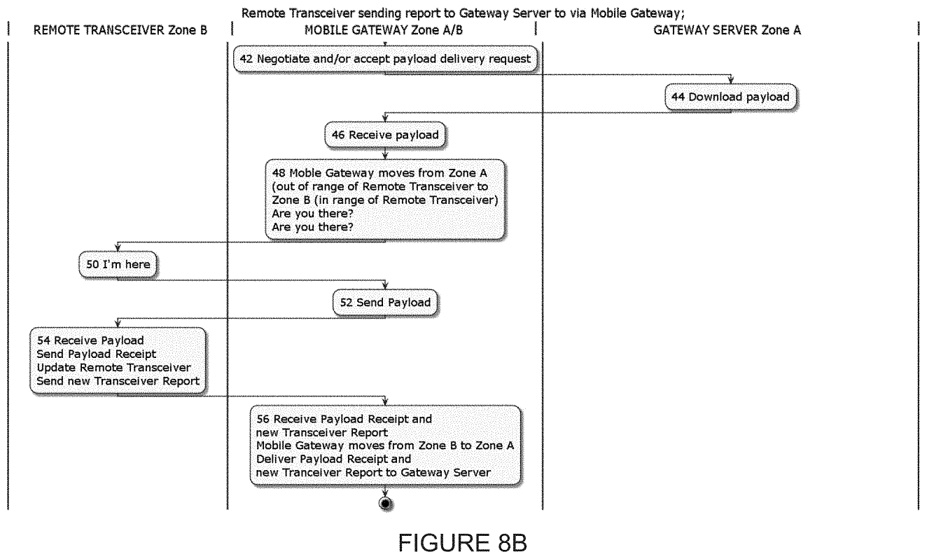

FIGS. 8A and 8B show a single swim lane interaction diagram example.

Referring to FIG. 1, transceiver gateway system 10A comprises: a gateway server 12A; mobile gateways 14A, 14B and 14C; and remote transceivers 16A to 16D. FIG. 1 covers two zones: zone A includes gateway server 12A and a single mobile gateway 14A; zone B is divided in a grid (X1 to X8, Y1 to Y7 including mobile gateways 14B and 14C and remote transceivers 16A to 16D. In zone A, a mobile gateway 14 (that is any of 14A to 14C if in zone A) would be in range of the gateway server 12A and in the example, MG 14A is shown in range in zone A with an arrow indicating a scheduled direction and destination (zone B coordinate X4Y7). In zone B, a mobile gateway 14 (that is any of 14A, 14B, 14C or 14D if in zone B) would be out of range of the gateway server 12A (in the example 14B and 14C are out of range). Mobile gateway 14B is located at grid reference X3Y5 with a scheduled direction and end location of zone A. Mobile gateway 14C is located at grid reference X7Y6 with a scheduled movement to zone A. Remote transceiver 16A is located at grid reference X1Y2. Remote transceiver 16B is located at grid reference X2Y5. Remote transceiver 16C and 16D are located at grid reference X6Y6. A mobile gateway schedule contains at least times and corresponding locations marking a route where the mobile gateway is to travel.

Referring to FIG. 2, transceiver gateway system 10B comprises: a gateway server 12B; mobile gateways (MG 14D to 14I and remote transceivers (labelled as RT but not individually numbered). FIG. 2 shows multiple zone B to zone I all out of range to gateway server 12B and divided into a grid. In zone A, a mobile gateway 14 (that is any of 14D to 14I if in zone A) would be in range of the gateway server 12B and in the example 14E and 14H are shown in range in zone A with arrows indicating a scheduled direction and destination (zone H for MG 14E and zone K for MG 14H). In zones B to I, a mobile gateway 14 (that is any of 14D to 14I if not in zone A) would be in out of range of the gateway server 12B and in the example 14D, 14F, 14G and 14I are out of range. Mobile gateway 14D is in zone D with a scheduled direction to zone A. Mobile gateway 14F is in zone I with a scheduled movement to zone A. Mobile gateway 14G is in zone G and mobile gateway 14I is in zone E.

Referring to FIGS. 3A, 3B and 3C, respective deployment diagrams for a gateway server 12, mobile gateway 14 and remote transceiver 16 of a first embodiment are described in terms of abstract inter-operational general purpose or special purpose computing processing system environments or configurations.

Gateway server 12 is a computer processing system comprising: a central processor unit (CPU) 120; memory 122 and a wide range transceiver 124 whereby the functions of the gateway server are performed locally to the wide range transceiver 124 (however it is envisaged that the functions of the gateway server can be also be implemented in a Cloud computing environment). Gateway server 12 uses wide range transceiver 124 to communicate with mobile gateway 14. Memory 122 comprises: gateway server module 126 and crowd source module 400. Gateway server module 126 is for co-ordinating mobile gateways. Crowd source module 400 is for performing the method the embodiment as described in more detail below.

Mobile gateway 14 is a computer processing system comprising: a central processor (CPU) 140; memory 142; multi-range transceiver 144; drive system 146 and battery 148 whereby the functions of the mobile gateway are performed locally by CPU 140 (however, it is also envisaged that the functions of the mobile gateway can be implemented in a portable computing solution such as a mobile phone that has no drive system and is mobile by virtue of being carried by an independent user or in a vehicle). Mobile gateway 14 uses a multi-range transceiver 144 to communicate with gateway server 12 when in range and with remote transceivers 16 when in range. Memory 142 comprises mobile gateway module 150 and mobile crowd source module 450. Mobile gateway module 150 is for coordinating movement of the mobile gateway 14 with drive system 146. Mobile crowd source module 450 is for performing the method of the embodiment as described in more detail below.

Remote transceiver 16 is a computing processing system comprising: a central processor 160; memory 162; low power transceiver 164; and battery 166. Remote transceiver 16 uses low power transceiver 164 to communicate with a mobile gateway 14 when in range. Memory 162 comprises remote transceiver module 168. Remote transceiver module 168 comprises components and instructions for controlling the remote transceiver 16 in a way that is independent of whether the mobile gateways are crowd sourced and is therefore not described further.

Examples of computing processing systems, environments, and/or configurations that may also be suitable for use as a gateway server 12, mobile gateway 14 and remote transceiver 16 include, but are not limited to, personal computer systems, server computer systems, thin clients, thick clients, hand-held or laptop devices, multiprocessor systems, microprocessor-based systems, network PCs, minicomputer systems, mainframe computer systems, and distributed computing environments that include any of the above systems or devices. A distributed computer environment includes a cloud computing environment for example where a gateway server is a third-party service performed by one or more of a plurality of computer processing systems.

Gateway server 12, mobile gateway 14 and remote transceiver 16 respectively comprise program modules containing executable instructions for execution by a computer processor. Generally, program modules may include: routines; programs; objects; components; logic; and data structures that control performance of processor tasks or implement particular abstract data types. Computer processing systems may be embodied in distributed cloud computing environments where tasks are performed by remote processing devices that are linked through a communications network. In a distributed cloud computing environment, program modules may be located in both local and remote computer system storage media including memory storage devices.

CPUs 120, 140 and 160 load executable instructions from respective modules to perform machine operations in response to the machine instructions. Such machine operations include: performing an operation on a value in a register (for example arithmetical or logical operations); moving a value from a register to a memory location directly and vice versa; and conditional or non-conditional branching. The CPUs can perform many different machine operations. The machine instructions are written in a machine code language which is referred to as a low-level computer language. A computer program written in a high-level computer language (also known as source code) needs to be compiled to a machine code program (also known as object code) before it can be executed by the processor. Alternatively, a machine code program such as a virtual machine or an interpreter can interpret a high-level language in terms of machine operations.

Memory 122, 142 and 162 can be volatile memory and non-volatile or persistent memory. Volatile memory is used for faster applications and non-volatile memory is used to hold the data for longer. Each computer processing system may further include other removable and/or non-removable, volatile and/or non-volatile computer system storage media. By way of example only, persistent memory can be provided for reading from and writing to a non-removable, non-volatile magnetic media (not shown and typically a magnetic hard disk or solid-state drive). As will be further depicted and described below, memory 122 and 142 includes a program product module comprising components and instructions for carrying out the functions of the embodiments. Further program modules that support the preferred embodiment but are not shown include firmware, boot strap program, operating system, and support applications. Each of the operating system; support applications; other program modules; and program data; or some combination thereof may include an implementation of a networking environment.

Referring to FIG. 4A, a component diagram for crowd source module 400 of the embodiment is described. Crowd source module 400 comprises: transceiver interface 404; mobile gateway identifying engine 406; remote transceiver identifying engine 408; data payload engine 410; download manager 412; incentive creator 414; upload manager 416; mobile prediction engine 418; transceiver location prediction engine 420; and crowd source method 500.

Transceiver interface 404 is for communicating with a mobile gateway.

Mobile gateway identifying engine 406 is for identifying participating mobile gateways from a plurality of communicating mobile gateways and for identifying mobile gateway information from received data.

Remote transceiver identifying engine 408 is for identifying individual remote transceivers from the received communications from a remote transceiver and for identifying remote transceiver information from the received data.

Data payload engine 410 is for identifying a data payload for delivery to an identified remote transceiver.

Download manager 412 is for managing a request to a participating mobile gateway for delivering an identified data payload to an identified remote transceiver.

Incentive creator 414 is for creating an incentive for including with the request whereby the incentive has a value that a potential participating mobile gateway might accept.

Upload manager 416 is for managing data exchange from mobile gateway (for example a mobile gateway schedule and including uploads that originate from a remote transceiver, for example a remote transceiver report). A mobile gateway schedule is a timetable including journey locations that may be ordered in terms of intended journey path and include an indication of time expected or planned.

Mobile prediction engine 418 is for making predictions about which mobile gateways will go where based on mobile gateway schedules, previous experience and discovered habits/patterns.

Transceiver location prediction engine 420 is for collecting historical remote transceiver locations and making location predictions on unknown or previously known remote transceivers. The transceiver prediction engine discovers patterns in historical and present remote transceiver locations and uses these patterns to make location suggestion or predictions to guide mobile gateways when looking for remote transceivers whose location is unknown. Remote transceiver location predications are then updated based on received remote transceiver location information.

Crowd source method 500 comprises the instructions, described in more detail below, for controlling the crowd source module 400 and for performing the embodiment.

Referring to FIG. 4B, a component diagram for a mobile crowd source module 450 of the embodiment is described. Mobile crowd source module 450 comprises: mobile transceiver interface 452; request engine 454; incentive engine 456; upload manager 458 and mobile crowd source method 600.

Mobile transceiver interface 452 is for communicating with a mobile gateway when in range and for communicating with one or more remote transceivers when in range.

Request engine 454 is for managing a participation request to deliver a data payload to a remote transceiver.

Incentive engine 456 is for accepting an incentive in included in the request if the incentive value is equal or more than an acceptable incentive value.

Upload manager 458 is for managing data exchange between remote transceivers and/or gateway servers.

Mobile crowd source method 600 comprises the instructions, described in more details below, for controlling the mobile crowd source module 450 and for performing the embodiment.

Referring to FIG. 5, crowd source method 500 comprises logical process instructions 502 to 518 for enabling performance of the embodiment in a gateway server, the gateway server is for exchanging data with a mobile gateway when the mobile gateway is in range of the gateway server, the mobile gateway is for moving into wireless range of the remote transceiver (the remote transceiver being out of range of the gateway server) and for exchanging data with the remote transceiver before moving back into range with the gateway server and further exchanging data to the gateway server. In the first embodiment, exchange is wireless, and the data includes mobile schedule/s, transceiver report/s, firmware update/s and queries.

Step 502 is for requesting participation and data from at least one mobile gateway.

Step 504 is for receiving participation acceptance with data and consolidating data. In the first embodiment, the received data includes transceiver reports and mobile gateway schedule/s.

Step 506 is for identifying transceivers from the received data. In the first embodiment, this is performed by remote transceiver identifying engine 408 using a transceiver report model.

Step 508 is for identifying a participating mobile gateway from the received data. In the first embodiment, this is performed by mobile gateway identifying engine 406 from the mobile gateway schedules using a schedule model.

Step 510 is for identifying a data payload for delivery to a transceiver by the participating mobile gateway. In the first embodiment, a data payload includes an update and/or a query for the transceiver and data payloads are received from an independent source (for example a transceiver application) and consolidated in a data payload model.

Step 512 is for requesting that the participating mobile gateway deliver a data payload to a remote transceiver and, after an acceptance, transmitting the data payload to the accepting mobile gateway for delivery to the remote transceiver. In the first embodiment, two or more accepted data payloads can be included in a single consolidated data payload for sending to the accepting mobile gateway. For important or urgent data, multiple participating mobile gateways can be requested to deliver the same payload to a remote transponder device thus introducing redundancy. An incentive may be offered for the first mobile gateway to deliver the payload, but an incentive may then be needed for at attempted delivery. If a second mobile gateway discovers that a particular payload has already been delivered to a particular remote transceiver by a first mobile gateway, then the second mobile gateway can abort delivery. Likewise, a remote transceiver can reject any attempts to receive data that it has already received, for instance, a payload may have a version or identifier that a remote transceiver can recognize as already delivered.

Step 514 is for optionally including, in the request to the participating mobile gateway, an incentive offer whereby acceptance of the request is also acceptance of the incentive offer. Optionally the incentive is an absolute value, or a negotiable value, or a request for a value. An incentive is offered and awarded for one or more of: receipt of transceiver report, receipt of mobile gateway schedule, and/or delivery of a data payload to a remote transceiver (and optionally partial delivery). In the first embodiment, the incentive is a payment amount transferred to a payment account in a payment system associated with the mobile gateway after receipt of delivery.

Step 516 is for optionally calculating an incentive value for a mobile gateway based upon a detour to an existing journey in the mobile gateway schedule. Alternately calculating an incentive value for a mobile gateway based upon an additional new journey for the mobile gateway schedule.

Step 518 is for optionally fulfilling a previously made incentive offer made by the gateway server.

This is the end of crowd source method 500.

Referring to FIG. 6, crowd source method 600 comprises logical process instructions 602 to 614 for enabling performance of the embodiment in a mobile gateway, the mobile gateway is for exchanging data with a gateway server when the mobile gateway is in range of the gateway server, the mobile gateway is for moving into wireless range of the remote transceiver (the remote transceiver being out of range of the gateway server) and for exchanging data with the remote transceiver before moving back into range with the gateway server and further exchanging data to the gateway server. In the first embodiment, exchange is wireless, and the data includes mobile schedule/s, transceiver report/s, firmware update/s and queries.

Step 602 is for receiving a request for data from a gateway server (once in range).

Step 604 is for sending data to gateway server. In the first embodiment, the sent data includes transceiver reports and mobile gateway schedule/s.

Step 606 is for receiving a request to deliver a data payload to a remote transceiver. In the first embodiment, a data payload may include an update and/or a query for the remote transceiver. Data payloads are received from an independent source (for example a transceiver application) and consolidated in a data payload model.

Step 608 is for determining whether to accept or reject the request.

Step 610 is for accepting the request and downloading the data payload for delivery to the remote transceiver. In the first embodiment, two or more accepted data payloads can be included in a single consolidated data payload for sending to the accepting mobile gateway.

Step 612 is for optionally including in the request an incentive offer whereby determining of the request comprises consideration of the incentive offer and acceptance of the request is also acceptance of the incentive offer (optionally the incentive is an absolute value, or an negotiable value, or a request for a value). An incentive is offered and awarded for one or more of: receipt of transceiver report, receipt of mobile gateway schedule, and/or delivery of a data payload to a remote transceiver (and optionally partial delivery). In the first embodiment, the incentive is a payment amount transferred to a payment account in a payment system associated with the mobile gateway after receipt of delivery.

Step 614 is for optionally calculating the cost of completing the data payload delivery and comparing the calculated cost with the incentive offer to determine acceptance or rejection of the request.

This is the end of mobile crowd source method 600.

Referring to FIG. 7A an example transceiver report data structure is described. This data structure is a table and each record in the table represents a transceiver report that has been received. Each record comprises the following fields: remote transceiver ID; location reference; power remaining; platform type; and firmware version. A transceiver report may be received by a mobile gateway with most of these fields and then formatted to be included in a transceiver report table. A mobile gateway may build a transceiver report table for sending to a gateway server or a mobile gateway may forward transceiver reports individually and the gateway server builds the table. The example given lists four transceivers: 1010, 1003, 1004, 1100 with respective location references: X1Y4; X2Y8; X3Y4; and X4Y6. The transceivers have respective remaining battery power of: 40%, 30%, 45% and 100%. The transceivers have respective platform types: P3; P3; P4 and P5. The transceivers have respective firmware versions: 2; 3; 3; and 1.

Referring to FIG. 7B an example mobile gateway schedule data structure is described. In this example the data structure is a table and there are two data fields for each record: day/time and location reference. Day/time is day value, for instance 1, 2, 3 or N with a time value in 24 hour format for example 1000h and 1200 h. Location reference concatenates two grid co-ordinates into one reference string so that location X1, Y2 is referenced as X1Y2. The mobile gateway schedule is independently created by each mobile gateway or a controlling entity and passed to the gateway controller. In the example, the mobile gateway plans or has been instructed to be: at location X1Y2 on day 3 at 1000H; at location X2Y6 on day 3 at 1200 h; at intermediate date/times and locations represented by ellipses; and finally, at location X3Y4 on day 4 at 1600 h.

Referring to FIG. 7C, example delivery request message 706 is described. A delivery request message comprises the following fields: remote transceiver; location reference; delivery package; delivery request; and incentive. Remote transceiver is the identifier of the remote transceiver to deliver a package to. Location reference contains the location where the mobile gateway will find the remote transceiver. Delivery package contains the details and the actual package for delivery. In the example, a delivery is requested of a data package called Xv3 with a size of 125 kB to a remote transceiver ID 1003 at location X2Y8. The specific request is for delivery of whole or partial package and the incentive is for 100 units per kB or 1500 units for full delivery and an updated status receipt. The latter is useful if there has been an error in the download so that the mobile gateway may need to repeat some or all of the delivery to receive a completed update status message and therefore the incentive.

Referring to FIG. 7D an example sensor data payload 708 data structure is described. Sensor data payload 708 is a table with a remote transceiver field, a location field, a day/time field and a sensor data field. In this example, there are multiple day/time and sensor data records for the same remote transceiver (and location). Remote transceiver is identified as 1010 at location X1Y4 with the following sensor data readings: Day1/1000 h=90; Day2/1000 h=80; Day3/1000 h=70; and Day4/1000 h=60. For example, the sensor data is a remote transceiver battery level percentage reading and the data shows that the battery is draining at 10% a day.

Referring to FIG. 7E an example sensor data payload 710 data structure is described comprising data from multiple sensors. This use case occurs when two or more remote transceivers are communicating with each other and pool data so that only one upload is required. Sensor data payload 710 is a table with a remote transceiver field, a location field, a day/time field and a sensor data field. In this example, there are multiple day/time and sensor data records for multiple remote transceivers (and respective locations). The first remote transceiver is identified as 1011 at location X1Y5 with the following sensor data readings: Day1/1000 h=60; Day2/1000 h=50; Day3/1000 h=40; and Day4/1000 h=30. The second remote transceiver is identified as 1012 at location X1Y5 with the following sensor data readings: Day1/1000 h=20; Day2/1000 h=10; Day3/1000 h=5; and Day4/1000 h=1. If the sensor data is a remote transceiver battery level percentage reading, then the data shows that the battery of remote transceiver 1012 is critically low. A similar pooling of data into a single data payload can occur when a mobile gateway passes multiple remote transceiver and consolidates the data in readiness to pass it on to a gateway server when in range.

Referring to FIGS. 8A and 8B, a single swim lane interaction diagram is described with interactions 22 to 56 according to a first embodiment whereby a remote transceiver in zone B sends a report to gateway server 12 in zone A via a mobile gateway 14 moving from zone B to zone A and then receives a payload from gateway server 12 via a mobile gateway 14 (not necessarily the same mobile gateway) moving from zone A to zone B.

In interaction 22 remote transceiver 16 transmits blind beacons to any listening mobile gateways thereby transmitting “I'm here” without knowing if any mobile gateway is listening. In the example, after the third transmission a mobile gateway 14 moves into listening range and picks up the fourth blind beacon.

In interaction 24, mobile gateway 14 discovers and registers the remote transceiver 16 from the “I'm here” signal and a response signal is sent “What's up?”.

In interaction 26, after receiving the “What's up?” signal the remote transceiver sends a transceiver report. The transceiver report includes at least: identifier information; location information; and status information relating to the remote transceiver device. If the remote transceiver is part of a tracking device, then the report will include tracking information. Location information may be derived from the mobile gateway's location if location technology is not part of the remote transceiver device.

In interaction 28, mobile gateway 14 receives the transceiver report.

In interaction 30, mobile gateway 14 moves from zone B (out of range of gateway server 12) to zone A (within range of gateway server B).

In interaction 32, gateway server 12 is requesting mobile gateway 14 contact.

In interaction 34, mobile gateway 14 receives the contact request.

In interaction 36, mobile gateway 14 delivers transceiver report. During this interaction, mobile gateway 14 can also deliver a mobile gateway schedule.

In interaction 38, the transceiver report is received. Further interactions are performed including: consolidating all received transceiver reports;

consolidating all received mobile gateway schedules; identifying a payload for a particular transceiver; determining a participating mobile gateway for delivering payload; and optionally determining an incentive offer for delivery of payload.

In interaction 40, a request to a participating mobile gateway is made to deliver the payload to the particular transceiver (and optionally for the incentive offer). The particular mobile gateway is not necessarily the same mobile gateway that delivered the transceiver report.

In interaction 42, the particular mobile gateway decides to negotiate and/or accept payload delivery request. A negotiation interaction occurs if decided (not shown). If the payload delivery request is declined, then a decline message is sent and that is the end of that particular interaction for that mobile gateway. In this example, the conclusion is to accept the payload delivery request with or without negotiation.

In interaction 44, the payload is sent/uploaded from the gateway server 12 and downloaded by the mobile gateway 14.

In interaction 46, the payload is received by the mobile gateway.

In interaction 48, the participating mobile gateway moves from zone A (out of range of the remote transceiver) to zone B (in range of remote transceiver) and broadcasts a beacon until it is received by the remote transceiver. “Are you there?”

In interaction 50, the remote transceiver receives the broadcasted beacon sends back a signal “I'm here”.

In interaction 52, the mobile gateway sends the payload to the remote transceiver.

In interaction 54, the remote transceiver receives the payload and sends a payload receipt. The remote transceiver may use the payload to update firmware or other onboard software and then send a new transceiver report with updated status.

In interaction 56, the mobile gateway receives the payload receipt and new transceiver report. The mobile gateway would then move from zone B to zone A to deliver the payload receipt and new transceiver report to the gateway server and start a new cycle of interactions.

The interactions repeat from the beginning or from an appropriate point.

As will be appreciated by one skilled in the art, the present techniques may be embodied as a system, method or computer program product. Accordingly, the present techniques may take the form of an entirely hardware embodiment, an entirely software embodiment, or an embodiment combining software and hardware.

Furthermore, the present techniques may take the form of a computer program product embodied in a computer readable medium having computer readable program code embodied thereon. The computer readable medium may be a computer readable signal medium or a computer readable storage medium. A computer readable medium may be, for example, but is not limited to, an electronic, magnetic, optical, electromagnetic, infrared, or semiconductor system, apparatus, or device, or any suitable combination of the foregoing.

Computer program code for carrying out operations of the present techniques may be written in any combination of one or more programming languages, including object-oriented programming languages and procedural programming languages.

For example, program code for carrying out operations of the present techniques may comprise source, object or executable code in a programming language (interpreted or compiled) such as C, or assembly code, code for setting up or controlling an ASIC (Application Specific Integrated Circuit) or FPGA (Field Programmable Gate Array), or code for a hardware description language such as Verilog™ or VHDL (Very high speed integrated circuit Hardware Description Language).

The program code may execute entirely on a computer, partly on the computer and partly on a remote computer or entirely on the remote computer or server. In the latter scenario, the remote computer may be connected to the computer through any type of network. Code components may be embodied as procedures, methods or the like, and may comprise sub-components which may take the form of instructions or sequences of instructions at any of the levels of abstraction, from the direct machine instructions of a native instruction set to high-level compiled or interpreted language constructs.

It will also be clear to one of skill in the art that all or part of a logical method according to the preferred embodiments of the present techniques may suitably be embodied in a logic apparatus comprising logic elements to perform the steps of the method, and that such logic elements may comprise components such as logic gates in, for example a programmable logic array or application-specific integrated circuit. Such a logic arrangement may further be embodied in enabling elements for temporarily or permanently establishing logic structures in such an array or circuit using, for example, a virtual hardware descriptor language, which may be stored and transmitted using fixed or transmittable carrier media.

In one alternative, an embodiment of the present techniques may be realized in the form of a computer implemented method of deploying a service comprising steps of deploying computer program code operable to, when deployed into a computer infrastructure or network and executed thereon, cause said computer system or network to perform all the steps of the method.

In a further alternative, the preferred embodiment of the present techniques may be realized in the form of a data carrier having functional data thereon, said functional data comprising functional computer data structures to, when loaded into a computer system or network and operated upon thereby, enable said computer system to perform all the steps of the method.

It will be clear to one skilled in the art that many improvements and modifications can be made to the foregoing exemplary embodiments without departing from the scope of the present techniques.

1. A gateway server for exchanging data with a remote transceiver using an intermediate mobile gateway that transports the data between the respective data ranges of the gateway server and the remote transceiver, said gateway server comprising:
a transceiver for requesting and receiving data from at least one mobile gateway;
a mobile gateway identifying engine for identifying a participating mobile gateway and mobile gateway information from the received data; and
a remote transceiver interface for identifying remote transceiver information from the received data.

2. The gateway server according to claim 1, wherein the remote transceiver interface is further for identifying a remote transceiver requiring delivery of a data payload, and said gateway server further comprises:
a data payload engine for identifying a data payload for delivering to an identified remote transceiver;
a delivery engine for requesting that a participating mobile gateway delivers the data payload to the identified remote transceiver; and
a download manager for downloading, on acceptance of the delivery request, the data payload to the accepting mobile gateway for delivery to the identified remote transceiver.

3. The gateway server according to claim 2, further comprising:
a transceiver location prediction engine for collecting historical and present remote transceiver locations, for making location predictions for the identified remote transceiver based on patterns in the collected historical and/or present remote transceiver locations and for providing the location predictions to the accepting mobile gateway.

4. The gateway server according to claim 1, wherein the mobile gateway information comprises one or more of: a mobile gateway identifier; mobile gateway report and/or a mobile gateway schedule.

5. The gateway server according to claim 1, wherein the remote transceiver information is uploaded from a remote transceiver after the mobile gateway encounters the remote transceiver, the remote transceiver information comprising one or more of: remote transceiver location; remote transceiver state; and/or remote transceiver logged data.

6. The gateway server according to claim 5, wherein the transceiver location prediction engine updates the location predictions based on received remote transceiver location information.

7. A mobile gateway for enabling exchange of data between a remote transceiver and gateway server by transporting the data between the respective data ranges of the gateway server and the remote transceiver prior to intermediate exchanges, the mobile gateway comprising:
a transceiver for receiving requests from a gateway server to participate in data transport by sending mobile gateway information and/or remote transceiver information to the gateway server;
a request engine for determining whether to accept or reject a participation request; and
an upload manager for managing exchanging of data when in wireless network range of a gateway server or a remote transceiver.

8. A method in a gateway server, the gateway server for exchanging data with a remote transceiver using an intermediate mobile gateway that transports the data between the respective data ranges of the gateway server and the remote transceiver, said method comprising:
requesting participation in data transport from at least one mobile gateway;
receiving data from a participating mobile gateway;
identifying, from the received data, remote transceiver information and/or mobile gateway information.

9. The method according to claim 8, further comprising:
identifying a remote transceiver requiring a data payload;
identifying a mobile gateway schedule that includes the identified remote transceiver's location;
requesting that the identified mobile gateway delivers the data payload to the identified remote transceiver; and
downloading, on acceptance of the delivery request, the data payload to the accepting mobile gateway for delivery to the identified remote transceiver.

10. The method according to claim 9, further comprising requesting that a mobile gateway moves into wireless range of a remote transceiver and exchange data with the remote transceiver.

11. The method according to claim 9, wherein two or more data payloads are included in a consolidated data payload for sending.

12. The method according to claim 9, wherein the same data payload request is made to more than one mobile gateway and more than one mobile gateway can deliver the payload to the remote transceiver.

13. The method according to claim 9, whereby the remote transceiver can download a whole payload from a single mobile gateway or can download portions of a payload from more than one mobile gateway.

14. The method according to claim 9, further comprising basing a data request on a predicted mobile gateway schedule, the predicted mobile gateway schedule based on a pattern in historical and/or present mobile gateway schedules.

15. The method according to claim 9, whereby a data request comprises a predicted remote transceiver location, the predicted remote transceiver location based on patterns in historical and/or present remote transceiver locations.

16. The method according to claim 15, further comprising:
updating the predicted remote transceiver location based on received remote transceiver location information.

17. The method according to claim 9, whereby the delivery request includes an incentive offer whereby acceptance of the delivery request is also acceptance of the incentive offer whereby the incentive offer is offered and awarded for one or more of: partial or whole delivery of a data payload to a remote transceiver; receipt of transceiver report; and/or receipt of a mobile gateway schedule, optionally the incentive offer comprises a payment transferred to a payment account associated with the mobile gateway on acceptance and/or after receipt of delivery.

18. The method according to claim 17, further comprising:
identifying previously accepted delivery requests and corresponding incentive offers made by the gateway server;
identifying a completed delivery request from the received data that matches an identified previously accepted delivery request made by the gateway server; and
fulfilling the corresponding incentive offer.

19. The method according to claim 18, whereby a completed mobile gateway request comprises: a partial or whole delivered data payload from the participating mobile gateway to a particular remote transceiver; receipt of transceiver report; and/or receipt of a mobile gateway schedule.

20. The method according to claim 18, whereby fulfilling the previously made incentive offer comprises transferring a payment to a payment account associated with the mobile gateway.

21. The method according to claim 18, further comprising:
identifying a remote transceiver requiring a data payload
identifying a data payload for the identified remote transceiver;
requesting that the identified participating mobile gateway deliver the data payload to the identified remote transceiver; and
downloading, on acceptance of the request, the data payload to the accepting mobile gateway for delivery to the identified remote transceiver.

22. A method in a mobile gateway, the mobile gateway for enabling exchange of data between a remote transceiver and a gateway server by transporting the data between the respective data ranges of the gateway server and the remote transceiver prior to intermediate exchanges, the method comprising:
receiving a request to participate in data transport by exchanging remote transceiver information and/or mobile gateway information;
determining whether to accept or reject the request; and
exchanging information with the remote transceiver and/or the gateway server.

23. The method according to claim 22, further comprising:
detecting a beacon signal from a remote transceiver when the mobile gateway is within communication range of the remote transceiver transmitting the beacon signal;
discovering the remote transceiver from the detected beacon signal;
transmitting a response signal to the discovered remote transceiver; and
receiving a transceiver report from the discovered remote transceiver.

24. The method according to claim 23, wherein the transceiver report includes at least: remote transceiver identifier information; remote transceiver location information; and status information relating to the remote transceiver.

25. The method according to claim 23, further comprising:
delivering the transceiver report to the gateway server when the mobile gateway is within communication range of the gateway server.

26. The method according to claim 22, further comprising:
receiving a request to deliver a data payload to a remote transceiver;
determining whether to accept or reject the request; and
downloading the data payload for delivery to the remote transceiver if accepted.

27. The method according to claim 26, wherein the request to deliver the data payload to the remote transceiver comprise a remote transceiver location prediction.

28. A method in a remote transceiver, the remote transceiver is for exchanging data with a mobile gateway when the mobile gateway has moved into communication range of the remote transceiver, thereafter the mobile gateway moves out of range of the remote transceiver and into communication range with a gateway server for exchanging data, including previously exchanged data with the gateway server, the method comprising:
receiving a participation request to exchange remote transceiver information with a mobile gateway;
determining whether to accept the participation request; and
exchanging data with the mobile gateway if acceptance is determined.

29. The method according to claim 28, further comprising:
transmitting a beacon signal periodically; and
following receipt of a beacon response signal from a mobile gateway, which has moved into communication range of the remote transceiver, transmitting a transceiver report to the mobile gateway.

30. The method according to claim 29, wherein the transceiver report includes at least: remote transceiver identifier information; remote transceiver location information; and status information relating to the remote transceiver.

31. A method in a networking system comprising a gateway server, a mobile gateway and a remote transceiver, the gateway server is for exchanging data with a mobile gateway when the mobile gateway is in range of the gateway server, thereafter the mobile gateway is for moving into wireless range of a remote transceiver and for exchanging data with the remote transceiver, said method comprising:
the gateway server requesting participation and data from at least one mobile gateway;
the gateway server receiving data from a participating mobile gateway;
the gateway server identifying, from the received data, remote transceiver information and/or mobile gateway information.

32. A computer program stored on a computer readable medium and loadable into the internal memory of a digital computer, comprising software code portions, when said program is run on a computer, for performing the method of claim 8.
